(19) United States
(12) Patent Application Publication
(10) Pub. No.: US 2013/0269622 A1
(43) Pub. Date: Oct. 17, 2013

(54) PET EXCREMENT BOX

(71) Applicant: Ernest CHARETTE, Sarnia (CA)

(72) Inventor: Ernest CHARETTE, Sarnia (CA)

(21) Appl. No.: 13/487,896

(22) Filed: Jun. 4, 2012

(30) Foreign Application Priority Data
Apr. 13, 2012 (CN) 201220155998.9

(51) Int. Cl. A01K 29/00

(52) U.S. Cl. 119/166; 294/1.3

(57) ABSTRACT

A pet excrement box includes an outer box (1) and an inner tray (2) which is detachable from the outer box (1). The outer box (1) has a V-shaped opening. At least one side of the outer box (1) is formed with an accommodation space (11) to accommodate the inner tray (2). The inner tray (2) has two sides perpendicular to the opening of the outer box (1) and each having a suspension portion (21). The suspension portion (21) is hanged on an edge of the accommodation space (11) of the outer box (1). The pet excrement box of the present invention can dump the excrements on the sands quickly. Ordinarily, the user can use a shovel (3) to clean the excrements on the inner tray (2). It is convenient and hygienic to clean the pet excrement box.

### BACKGROUND OF THE INVENTION

1. Field of the Invention

The present invention relates to a pet excrement box, and more particularly, to a pet excrement box which can be cleaned with ease.

2. Description of the Prior Art

The standard of living gradually enhances, raising a pet becomes more and more popular. However, the surrounding becomes worse due to the pet excrements. In order to improve the surrounding, many pet appliances are developed, such as a pet excrement box. The configuration of the conventional pet excrement box is simple and it is not convenient to clean the pet excrement box. After using several times, the pet excrement may stain the box. It is difficult to clean the excrement box.

Accordingly, the present invention intends to provide a pet excrement box for improving the shortcomings mentioned above.

### SUMMARY OF THE INVENTION

The primary object of the present invention is to provide a pet excrement box which can dump the excrements on the sands quickly. Ordinarily, the user can use the shovel to clean the excrements on the inner tray. It is convenient and hygienic to clean the pet excrement box.

The pet excrement box of the present invention comprises an outer box and an inner tray which is detachable from the outer box. The outer box has a V-shaped opening. At least one side of the outer box is formed with an accommodation space to accommodate the inner tray. The inner tray has two sides perpendicular to the opening of the outer box and each having a suspension portion. The suspension portion is hanged on an edge of the accommodation space of the outer box.

Preferably, the outer box comprises two semi boxes connected to each other and a plurality connection buckles arranged in a line and located between the two semi boxes. The connection buckles is connected with one another.

Preferably, the pet excrement box further comprises two semi-circle engaging plates. The two engaging plates are disposed at the tip of the V-shaped opening of the outer box.

Preferably, the engaging plates have a plurality of positioning tenons. Two sides of each semi box respectively have a plurality of positioning holes. The positioning tenons of the engaging plates respectively engage with the positioning holes of the two semi boxes to secure the two semi boxes at an angle.

Preferably, the pet excrement further comprises a stop side. The stop side has an engaging buckle at a perimeter thereof. The stop side is connected to an upper edge of the inner tray.

Preferably, the inner tray has a net bottom.

Preferably, each of the two semi boxes has the accommodation space.

Preferably, the pet excrement box further comprises a shovel to clean the excrements in the inner tray.

Preferably, the engaging plates have at least one hook to secure a dustproof cover.

Compared to the prior art, the pet excrement box of the present invention can dump the excrements on the sands quickly. Ordinarily, the user can use the shovel to clean the excrements on the inner tray. It is convenient and hygienic to clean the pet excrement box.

### BRIEF DESCRIPTION OF THE DRAWINGS

FIG. 1 is a perspective view according to a preferred embodiment of the present invention;

FIG. 2 is a schematic view showing the outer box in an open state according to the preferred embodiment of the present invention;

FIG. 3 is a side view showing the outer box according to the preferred embodiment of the present invention;

FIG. 4 is a perspective view showing the outer box according to the preferred embodiment of the present invention;

FIG. 5 is a perspective view showing the inner tray according to the preferred embodiment of the present invention;

FIG. 6 is a perspective view showing the inner tray cooperating with the stop side according to the preferred embodiment of the present invention;

FIG. 7 is a perspective view showing the shovel according to the preferred embodiment of the present invention; and

FIG. 8 through FIG. 13 show the preferred embodiment of the present invention when in use.

### DETAILED DESCRIPTION OF THE PREFERRED EMBODIMENTS

Embodiments of the present invention will now be described, by way of example only, with reference to the accompanying drawings.

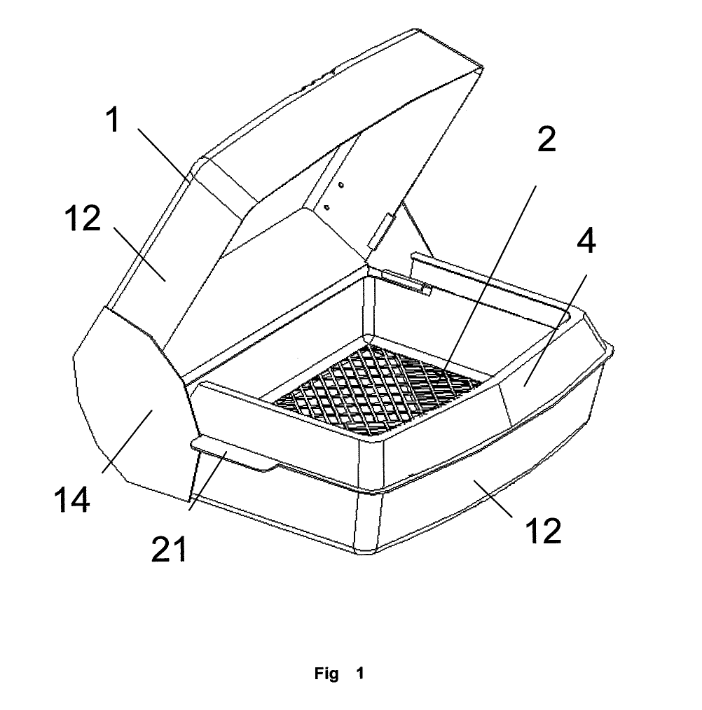

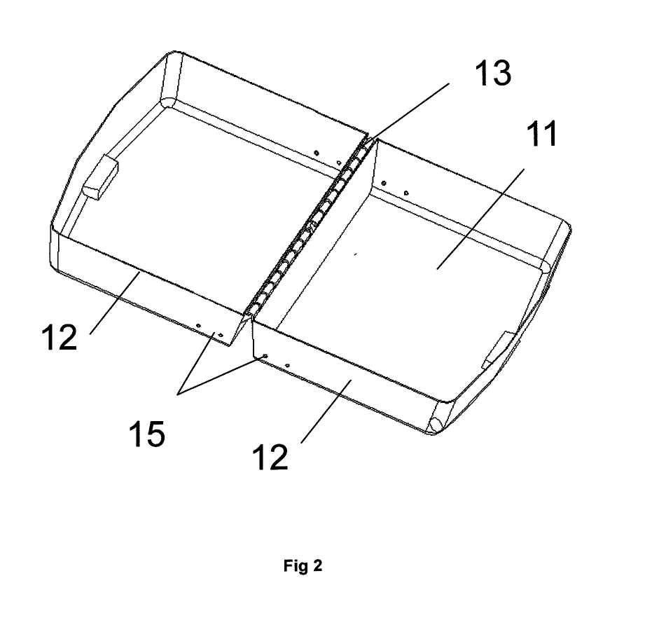

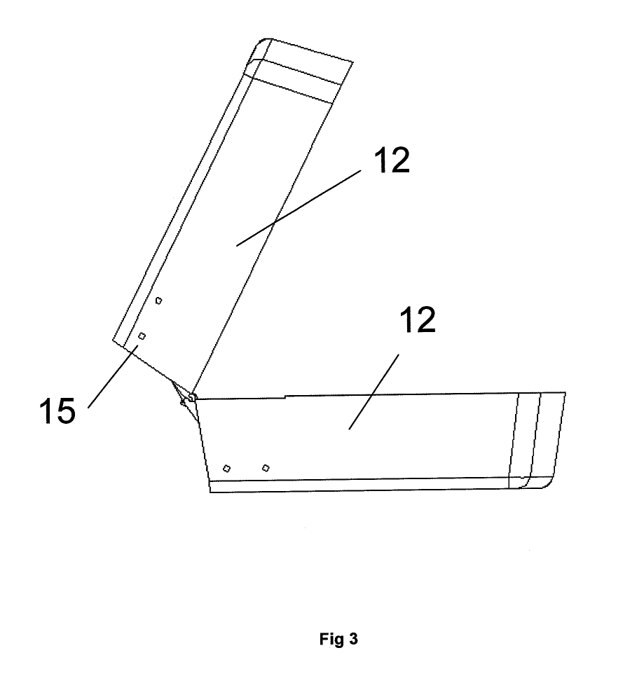

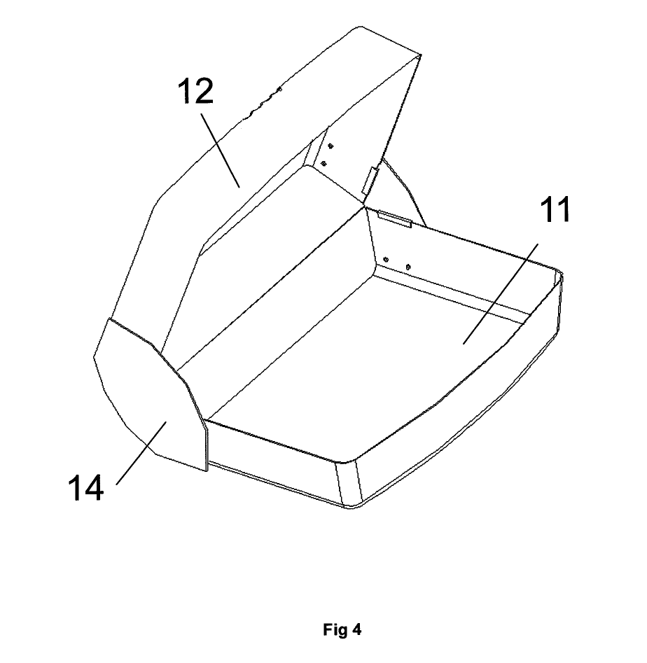

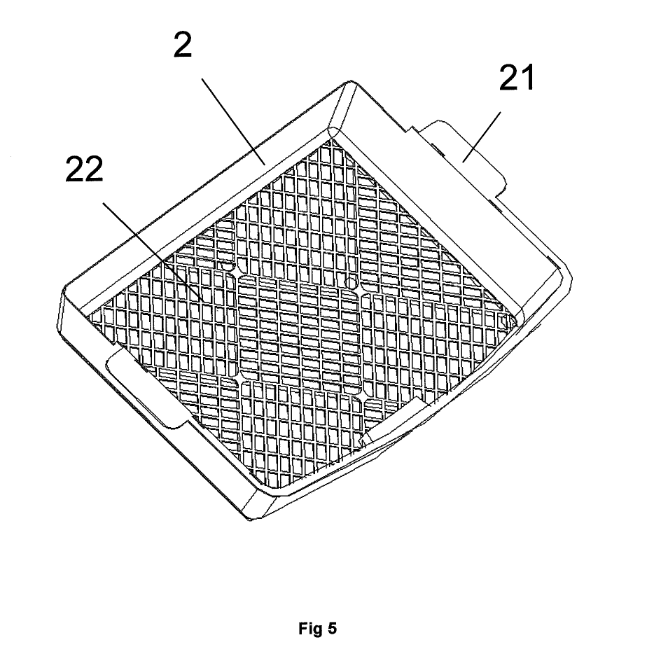

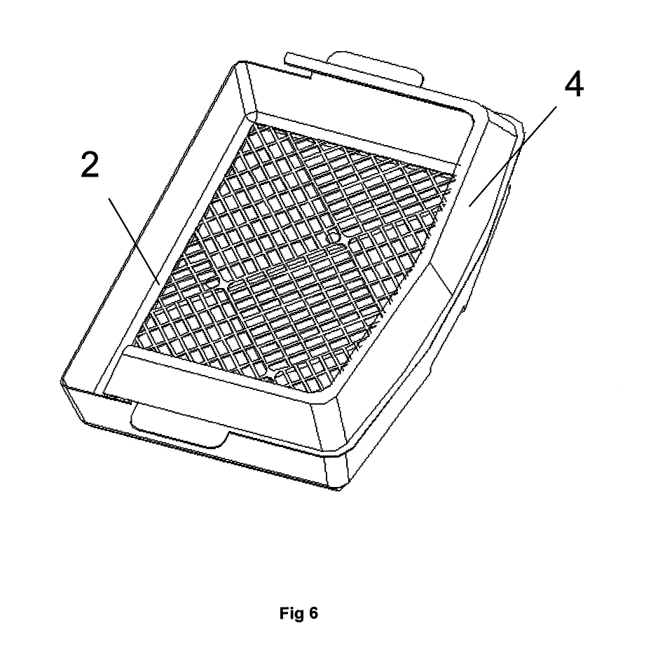

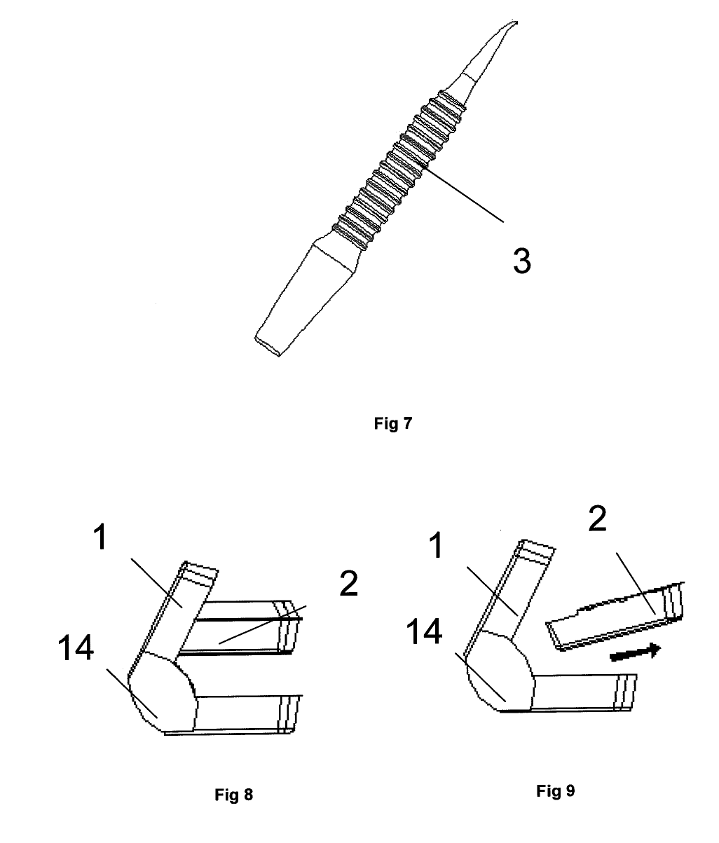

As shown in FIG. 1 through FIG. 13, the pet excrement box according to a preferred embodiment of the present invention comprises an outer box 1 and an inner tray 2 which is detachable from the outer box 1. The outer box 1 has a V-shaped opening. The outer box 1 has two sides each formed with an accommodation space 11 to accommodate the inner tray 2. The inner tray 2 has two sides perpendicular to the opening of the outer box 1 and each having a suspension portion 21. The suspension portion 21 is hanged on an edge of the accommodation space 11 of the outer box 1. The outer box 1 comprises two semi boxes 12 connected to each other and a plurality connection buckles 13 arranged in a line and located between the two semi boxes 12. The connection buckles 13 are connected with one another. The outer box 1 further comprises two semi-circle engaging plates 14. The two engaging plates 14 are disposed at the tip of the V-shaped opening of the outer box 1. The engaging plates 14 have a plurality of positioning tenons. The two sides of each semi box 12 respectively have a plurality of positioning holes 15. The positioning tenons of the engaging plates 14 respectively engage with the positioning holes 15 of the two semi boxes 12 to secure the two semi boxes 12 at an angle. Each of the two sides of the outer box 1 can be used to accommodate the inner tray 2. The curve of the engaging plates 14 facilitates the outer cover 1 to be overturned with ease.

The present invention further comprises a stop side 4. The stop side 4 has an engaging buckle at a perimeter thereof. The stop side 4 is connected to an upper edge of the inner tray 2. The stop side 4 can increase the height of the inner tray 2, preventing sands in the tray 2 from being flung out of the box.

The inner tray 2 has a net bottom 22. The present invention further comprises a shovel 3 to clean the excrements in the inner tray 2.

The outer box 1 comprises the two semi boxes 12 which are connected to each other through the engaging plates 14. In this way, the outer box 1 can be delivered conveniently. The space occupied by the two stacked semi boxes 2 is less than that of the V-shaped outer box 1. The engaging plates 14 have at least one hook to secure a dustproof cover.

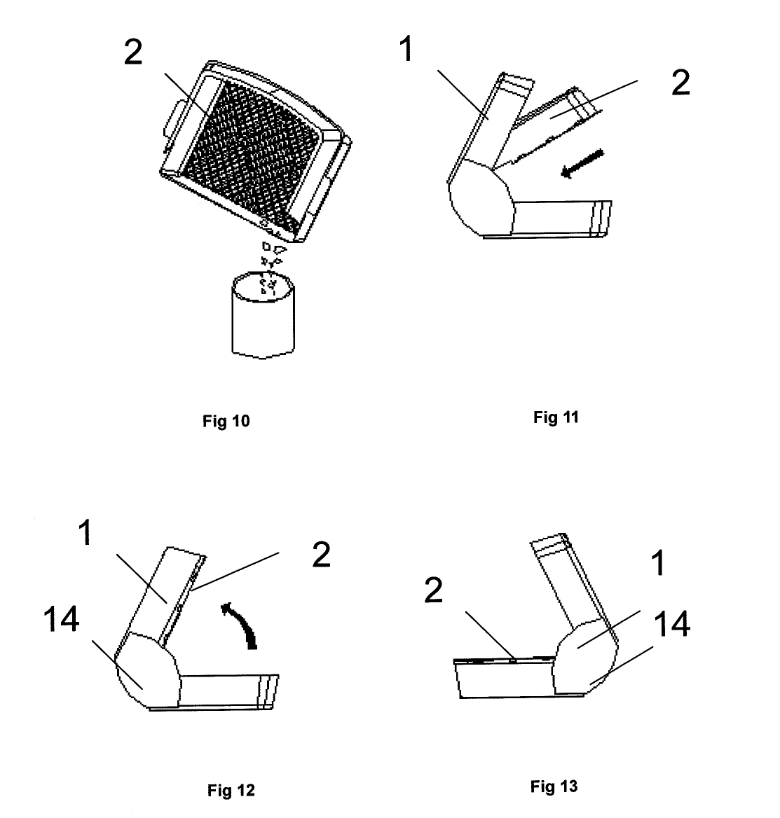

FIG. 8 through FIG. 13 show the use process of the present invention. As shown in FIG. 8, the two suspension portions 21 of the inner tray 2 is lifted to separate the inner tray 2 from the outer box 1. As shown in FIG. 9, the inner tray 2 is taken out from the outer box 1. As shown in FIG. 10, the excrements in the inner tray 2 are dumped. As shown in FIG. 11, the inner tray 2 is inserted in the other side of the outer box 1. As shown in FIG. 12, the inner tray 2 is placed back the other side of the outer box 1. As shown in FIG. 13, the outer box 1 is overturned along the engaging plates 14, so that the other side of the outer box is on the ground.

Accordingly, the pet excrement box of the present invention can dump the excrements on the sands quickly. Ordinarily, the user can use the shovel to clean the excrements on the inner tray. It is convenient and hygienic to clean the pet excrement box.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. A pet excrement box, comprising an outer box (1) and an inner tray (2) detachable from the outer box (1), the outer box (1) having a V-shaped opening, at least one side of the outer box (1) being formed with an accommodation space (11) to accommodate the inner tray (2), the inner tray (2) having two sides perpendicular to the opening of the outer box (1) and each having a suspension portion (21), the suspension portion (21) being hanged on an edge of the accommodation space (11) of the outer box (1).

2. The pet excrement box as claimed in claim 1, wherein the outer box (1) comprises two semi boxes (12) connected to each other and a plurality connection buckles (13) arranged in a line and located between the two semi boxes (12), the connection buckles (13) being connected with one another.

3. The pet excrement box as claimed in claim 2, further comprising two semi-circle engaging plates (14), the two engaging plates (14) being disposed at a tip of the V-shaped opening of the outer box (1).

4. The pet excrement box as claimed in claim 3, wherein the engaging plates (14) have a plurality of positioning tenons, two sides of each semi box (12) respectively having a plurality of positioning holes (15), the positioning tenons of the engaging plates (14) respectively engaging with the positioning holes (15) of the two semi boxes (12) to secure the two semi boxes (12) at an angle.

5. The pet excrement box as claimed in claim 4, further comprising a stop side (4), the stop side (4) having an engaging buckle at a perimeter thereof, the stop side (4) being connected to an upper edge of the inner tray (2).

6. The pet excrement box as claimed in claim 4, wherein the inner tray (2) has a net bottom (22).

7. The pet excrement box as claimed in claim 4, wherein each of the two semi boxes (12) has the accommodation space (11).

8. The pet excrement box as claimed in claim 4, further comprising a shovel (3) to clean excrements in the inner tray (2).

9. The pet excrement box as claimed in claim 4, wherein the engaging plates (14) have at least one hook to secure a dustproof cover.
